(19) United States
(12) Patent Application Publication
(10) Pub. No.: US 2010/0250526 A1
(43) Pub. Date: Sep. 30, 2010

(54) Search System that Uses Semantic Constructs Defined by Your Social Network

(76) Inventors: Filip Procházka, Adamov (CZ); Zdenko Stanícek, Tisnov (CZ)

Correspondence Address: MEYERTONS, HOOD, KIVLIN, KOWERT & GOETZEL, P.C., P.O. BOX 398, AUSTIN, TX, 78767-0398, US

(21) Appl. No.: 12/731,919

(22) Filed: Mar. 25, 2010

Related U.S. Application Data
(60) Provisional application No. 61/164,231, filed on Mar. 27, 2009.

(51) Int. Cl. G06F 17/30

(52) U.S. Cl. 707/723; 707/769; 707/E17.014

(57) ABSTRACT

A search mechanism that involves receiving input that specifies a search term, e.g., a word or sequence of words. The input is received via a computer network from a user. The search term has an associated meaning that has been defined by the user, one or more members of the user's social network, and/or, a provider of an Internet-based service. The search mechanism may also involve searching a database based on the search term to obtain search results, and sending at least a portion of the search results to the user via the Internet. The search mechanism may also perform searches based on a user-specified phrase that is composed of a number of search terms.

### RELATED APPLICATION DATA

This application claims the benefit of priority to U.S. Provisional Application No. 61/164,231, filed on Mar. 27, 2009, titled “Search Engine that Uses Semantic Constructs Defined by Your Social Network”, invented by Filip Procházka and Zdenko Staní\check{c}ek. That Provisional Application (including its Appendix) is hereby incorporated by reference in its entirety.

### FIELD OF THE INVENTION

The present invention relates to search technology, and more particularly, to a mechanism for performing network-based searches that takes advantage of knowledge inherent in a social network.

### DESCRIPTION OF THE RELATED ART

At the present time, Internet-based search engines allow a user to perform searches by typing words into a search input field. However, the user typically operates solo, without the benefit of the wisdom of others, e.g., others who might know much more about the subject the user is interested in exploring. Thus, there exists a need for a mechanism capable of providing search services in a manner that is socially informed.

### SUMMARY OF THE INVENTION

In one set of embodiments, a computer-implemented method may involve receiving input that specifies a search term (e.g., a word or sequence of words). The input is received via a computer network (e.g., the Internet) from a user, i.e., from a client computer that is controlled by the user. The search term has an associated meaning that has been defined by: the user, a member of the user's social network, and/or a provider of an Internet-based service, where the social network member is different from the user.

The method may also involve searching a database based on the search term to obtain search results, and sending at least a portion of the search results to the user via the Internet.

The meaning of a search term may be constructed by combining previously existing meanings. The method may involve providing the user with access to a dictionary of fundamental meanings and to the personal dictionaries of other members in the user's social network. The method may also involve providing the user with access to a dictionary supplied by the service provider.

In another set of embodiments, a computer-implemented method may involve receiving input from a user that specifies or selects a search term (e.g., a word or sequence of words), where the search term has an associated meaning that has been defined by: the user, a member of the user's social network, and/or a provider of an Internet-based service, where the social network member is different from the user.

The method may further involve: sending the search term to a server via a computer network (e.g., the Internet); receiving search results corresponding to the search term from the server; and displaying the search results.

In one set of embodiments, a user may connect to a search service through a computer network such as the Internet. The service provides a basic dictionary of terms with associated meanings. The user may build his/her own terms (or meanings) by specifying combinations of the terms in the dictionary and assigning a name to the newly constructed combination. Each user has his/her own unique perspective on the world, e.g., unique knowledge, experience and interests. Thus, he/she may define terms differently from others. The search service allows a user to have access to terms that have been defined by other users. Thus, a user may conduct a search based on a term that has been defined by another user. Or, the user may construct a term that includes one or more terms that have been defined by one or more other users of the service, and then employ that constructed term to perform a search. The service may store the social network of each user, i.e., the set of other users that each user is related to. (The user may control who is allowed to become a member of his/her social network.) Thus, each user may gain the benefit of the collected wisdom and experience of his/her social network when performing searches through the search service.

Any of the method embodiments described herein may be encoded in terms of program instructions and stored on any of a variety of memory media. The present invention also contemplates computer systems being configured to execute any of the method embodiments described herein.

### BRIEF DESCRIPTION OF THE DRAWINGS

FIG. 1 illustrates a computer system according to one set of embodiments.

FIG. 1B is an example of an AND/OR tree.

FIG. 1C is an example of a T-structure that represents the relationship between a father (John) and his son (Matt) relative to the context K.

FIG. 2 illustrates one embodiment of a search method.

FIG. 3 illustrates another embodiment of a search method.

FIG. 4 illustrates yet another embodiment of a search method.

FIG. 5 illustrates one embodiment of a search method from the client's point of view.

FIG. 6 illustrates one embodiment of an attention map generated in response to the search term: “ded manager phones (David (e-shop)), by producers, by price level”.

FIG. 7 illustrates one embodiment of an attention map generated in response to the search term: “recommended manager phones (David (e-shop)), by producers”.

FIG. 8 illustrates one embodiment of a map of customer groups generated by an analytical engine.

FIG. 9 illustrates a map showing information regarding a particular group, i.e., “working men”.

FIG. 10 illustrates an example search based on the search term: “recommended manager phones (david), top phones (lucas), by producers”.

FIG. 11 illustrates one embodiment of respective functions performed by a social networker, an analyzer and evolver, a map composer and map renderer.

FIG. 12 illustrates one embodiment of a “customer behavior analysis” view.

FIG. 13 illustrates one embodiment for a system architecture of the search system.

FIG. 14 illustrates another embodiment for a system architecture of the search system.

While the invention is susceptible to various modifications and alternative forms, specific embodiments thereof are shown by way of example in the drawings and are herein described in detail. It should be understood, however, that the drawings and detailed description thereto are not intended to limit the invention to the particular forms disclosed, but on the contrary, the intention is to cover all modifications, equivalents and alternatives falling within the spirit and scope of the present invention as defined by the appended claims.

### DETAILED DESCRIPTION OF EMBODIMENTS OF THE INVENTION

The present invention may be realized in any of various forms. For example, in some embodiments, the present invention may be realized as a computer-implemented method, a computer-accessible memory medium, a computer system, a set of computer systems interconnected via a network, a set of one or more integrated circuits, or any combination thereof.

A memory medium is a medium configured for the storage and retrieval of information. Examples of memory media include: various kinds of semiconductor memory such as RAM and ROM; various kinds of magnetic media such as magnetic disk, tape, strip and film; various kinds of optical media such as CD-ROM and DVD-ROM; various media based on the storage of electrical charge, magnetization, and/or other physical quantities; media fabricated using lithographic techniques; etc.

A computer-accessible memory medium is a memory medium that stores program instructions and/or data, where the program instructions are executable by a computer system to implement a method, e.g., any of a method embodiments described herein, or, any combination of the method embodiments described herein, or, any subset of any of the method embodiments described herein, or, any combination of such subsets.

In some embodiments, a computer system may be configured to include a processor (or a set of processors) and a memory medium. The memory medium stores program instructions. The processor is configured to read and execute the program instructions from the memory medium. The program instructions are executable to implement a method, e.g., any of the various method embodiments described herein, or, any combination of the method embodiments described herein, or, any subset of any of the method embodiments described herein, or, any combination of such subsets. The computer system may be realized in any of various forms. For example, the computer system may be a personal computer (in any of its various realizations), a workstation, a computer on a card, a server computer (or a system of interconnected server computers), a client computer, a hand-held device, a cell phone, a mobile device, a personal digital assistant, a wearable computing device, a head-mounted computing device, etc.

In some embodiments, a server computer system may be configured to provide a search service for client computers via a computer network such as the Internet. Various embodiments of the server system are contemplated to support various orders of magnitude for the number of clients or various orders of magnitude for the expected total bandwidth of client accesses to the server system.

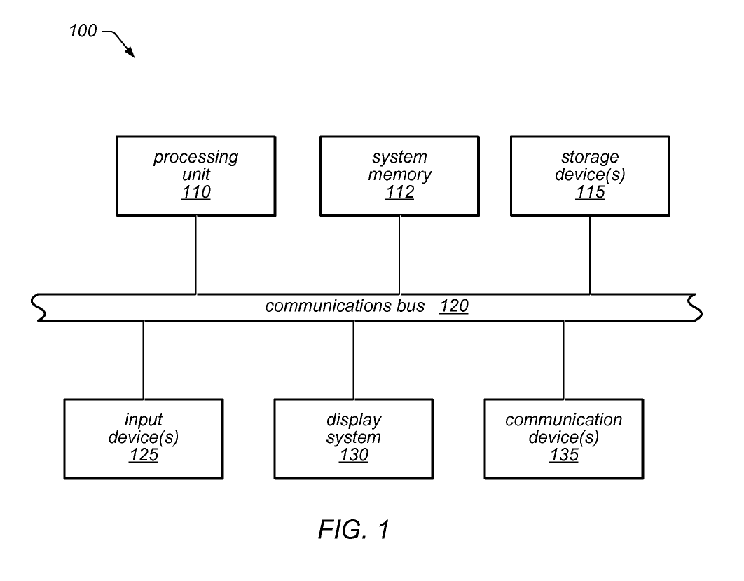

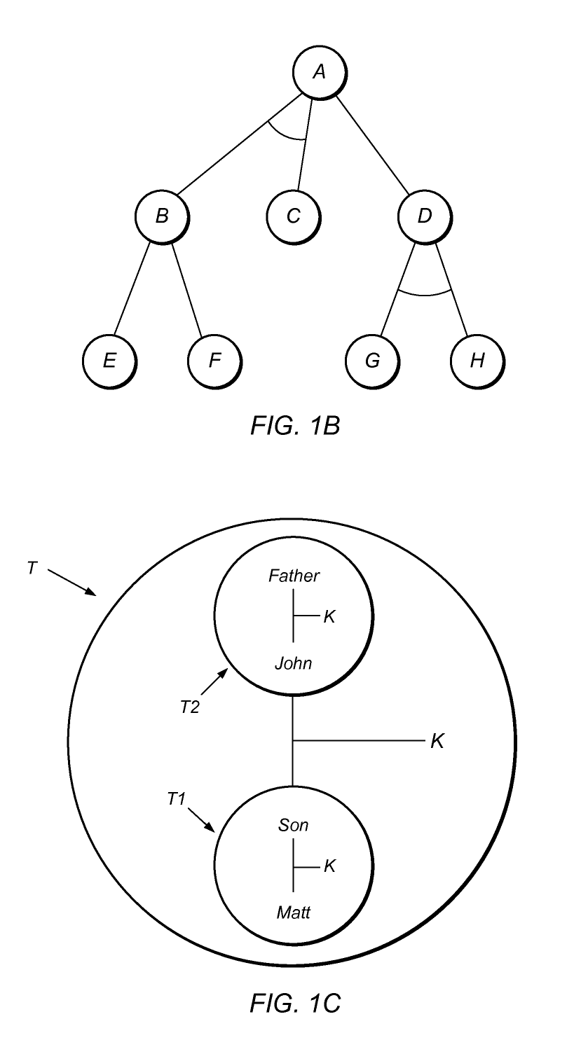

FIG. 1 illustrates one embodiment of the computer system 100 that may be used to perform any of the method embodiments described herein, or, any combination of the method embodiments described herein, or, any subset of any of the method embodiments described herein. Computer system 100 may include a processing unit 110, a system memory 112, a set 115 of one or more storage devices, a communication bus 120, a set 125 of input devices, and a display system 130.

System memory 112 may include a set of semiconductor devices such as RAM devices (and perhaps also a set of ROM devices).

The set of storage devices 115 may include any of various storage devices such as one or more memory media and/or memory access devices. For example, storage devices 115 may include devices such as a CD-ROM drive, a hard disc, a magnetic disk drive, magnetic tape drives, a semiconductor-based memory device, etc.

Processing unit 110 is configured to read and execute program instructions, e.g., program instructions stored in system memory 112 and/or on one or more of the storage devices 115. Processing unit 110 may couple to system memory 112 through communication bus 120 (or through a system of interconnected busses). The program instructions configure the computer system 100 to implement a method, e.g., any of the method embodiments described herein, or, any combination of the method embodiments described herein, or, any subset of any of the method embodiments described herein, or, any combination of such subsets.

Processing unit 110 may include one or more programmable processors (e.g., microprocessors). In some embodiments, the processing unit 110 includes a plurality of processing cores.

One or more users may supply input to the computer system 100 through the set 125 of input devices. Input devices 125 may include devices such as a keyboard, a mouse, a touch-sensitive pad, a touch-sensitive screen, a digital drawing pad, a track ball, a light pen, a data glove, eye orientation and/or head orientation sensors, a microphone (or set of microphones), or any combination thereof.

The display system 130 may include any of a wide variety of display devices representing any of a wide variety of display technologies. For example, the display system may be a computer monitor, a display screen, a head-mounted display, a projector system, a volumetric display, or any combination thereof. In some embodiments, the display system may include a plurality of display devices. In some embodiments, the display system is integrated with a tactile input interface so that a user can provide input to the computer system by tactile actions on the display screen surface.

In some embodiments, the computer system 100 may include other devices, e.g., devices such as a speaker (or set of speakers), a sound card, a video camera and a video card.

In one embodiment, computer system 100 may include one or more communication devices 135. For example, the communication devices 135 may include a network interface for interfacing with a computer network such as the Internet and/or a privately-owned computer network. The network interface may be realized by any of various known technologies for interfacing a computer to a network. For example, the network interface may be wired or wireless, or fiber-based or not fiber-based. In one embodiment, the network interface is an Ethernet card.

The computer system 100 may be configured with a software infrastructure including an operating system, and perhaps also one or more graphics API (such as OpenGL®, Direct3D, Java 3D™). Any of various known operating systems are contemplated.

In some embodiments, computer system 100 may be specialized for performance as a server system to implement one or more of the server method embodiments described herein. In other embodiments, computer system 100 may be specialized for performance as a client computer to implement one or more of the client method embodiments described herein. Server systems will typically have a greater need for processing speed and memory capacity than client systems.

It is noted that different client computers may be configured differently. For example, one client computer may be a desktop computer, another client computer may be laptop, a third client computer may be a hand-held device, a fourth client computer may be cell phone, etc.

The system architecture of computer system 100 shown in FIG. 1 is to be interpreted as one of many possible architectures for a computer system. Computer systems conforming any known architecture or combination of architectures are contemplated.

In some embodiments, a semantic search engine may be configured to search a database of data items, preferably a database that has been indexed according to an indexing scheme. The search may be performed based on words or word sequences specified and/or selected by the user.

The semantic search engine may execute on a server that is connected to a computer network such as the Internet. A user may access the server through the computer network, e.g., using a client computer that is equipped with a web browser or with some other software utility.

The database may include a portion that stores one or more graphs (e.g., graphs in the graph theoretic sense). The graphs have nodes and edges. In some embodiments, the database may be an SQL database or an SQL database with one or more extensions.

The semantic search engine is configured to use words (or word sequences) whose meanings are dependent on the user and/or the user's social network. Thus, the same word may have different meanings to different users. Also, different users may use different words but with the same meaning.

The semantic search engine allows the user to define the meanings of words and share word meanings with other users. More generally, the user may define word sequences, which are referred to herein as “n-grams”, where n is a positive integer. Thus, a single word is a 1-gram, while a word sequence with five words is a 5-gram, and so forth.

The semantic search engine may be used in any of a wide variety of applications. For example, in one embodiment, the semantic search engine may be used to search for goods in web-based stores (e.g., eShops), where users and communities of users can define and share n-gram meanings with each other.

Each user may have a personal account with the server. The account includes the n-grams the user has defined. The user can allow other users (or sets of users) of the server to have access to his/her list of n-grams. When constructing a search string for a given search, a user can use n-grams defined in his/her account. In one embodiment, the user can also use n-grams defined in any account of his/her social network.

The social network of a user is the set of one or more other users with whom the user is related. The social network can be either open or public (e.g., such as FACEBOOK) or closed or private (e.g., such as CVMAGIC in the Czech Republic). Information specifying the user's social network may be stored as part of the user's account. (Information specifying the user's social network may be received from a social networking service such as Facebook, LinkedIn, MySpace, etc.)

In other embodiments, the semantic search engine may be used for searching job offers, for searching offers for service, for searching real estate properties, for searching events generated by monitoring systems, etc.

Each user may define n-grams according to his/her unique pattern of perceptions, preferences, life experience, beliefs, etc. For example, a user interested in mountaineering may have her own definition of the term “outdoor pants suitable for mountaineering” that is constructed from more fundamental terms such as “pants”, “durable”, “warm” and “flexible”. Furthermore, a user may use n-grams whose meanings have been defined by one or more other users in his/her social network. For example, a user may decide to use his friend's definition of the term “stylish phone”, knowing that the friend has a keen sense of style in the design of electronic devices. Another user interested in learning how to fish may use his uncle's definition for “fishing rods for newbies”. Yet another user may combine the term “stylish phone” defined by a first friend and the term “inexpensive phone” defined by a second friend with an intersection operator, in order to search for phones falling in the intersection of the two definitions, knowing that the first friend is an expert on style and the second friend is a expert on minimizing cost.

The semantic search engine performs a search based on a search string provided by the user. The search string includes one or more n-grams specified by the user. The result of a search may be represented as a graph (e.g., a network) that includes nodes and edges. This graph is referred to herein as an “attention map”. The nodes represent database items that have been discovered by the search process. The edges represent relationships between the nodes.

In one embodiment, the semantic search engine may generate the edges of the attention map based on existing relations in the database. For example, if there is a connection in the database between a product and a producer with the meaning “producer of the given product”, the two nodes representing a product and producer, respectively, may be connected by an edge labeled with “producer of the given product”. In other embodiments, other more complicated schemes may be used to generate the edges of the attention map. For example, two nodes may be connected with an edge if a specific computation procedure discovers a hidden relationship between the respective nodes. In one embodiment, such a procedure can be a similarity search procedure (e.g., one that determines if two products are visually similar).

The semantic search engine may assign an attention value to each of the nodes and/or each of the edges of the attention map. The attention value of a node or edge may be interpreted as an estimate of the extent to which that node/edge is worthy of the user's attention. The semantic search engine may rank the nodes and/or edges of the attention map according to attention value.

In one embodiment, the attention map may be filtered to remove nodes and/or edges with low attention value, e.g., nodes and/or edges having attention value less than a user-specified threshold. The result of the filtering operation is referred to as a filtered attention map. The filtered attention map may be visually displayed to the user. In one embodiment, the user may control a global attention threshold value. As the user increases/decreases the global threshold, the number of items in the filtered attention map, and thus, the number of items displayed to the user increases/decreases.

In some embodiments, the attention map may be filtered according to a set of one or more attention filtering rules. An attention filtering rule specifies a condition under which nodes and/or edges are to be removed from the attention map.

In some embodiments, the semantic search engine distinguishes between different types of nodes and/or edges and performs filtering according those types. For example, an attention map may contain two types of nodes—objects and categories. Examples of objects include: “phone Nokia 3710”, “phone Nokia 5800”. Examples of categories include: “cell phone”, “cheap”. Edges may be between objects, between object and category, and between categories as well. The filtering of objects can be based on a simple threshold method as described above, while the filtering of categories can be based on the rule, “category node will be filtered if it is connected with a filtered object node”.

Other rules may be used to resolve apparent contradictions, e.g., what to do if the edge is ranked with high attention value, but its respective nodes hold no attention. There may be various strategies depending on the specific situation; various strategies may require various sets of rules.

In some embodiments, the edges of the attention map are directed (i.e., oriented) edges. The directed edges may indicate relationships between nodes, e.g., relationships such as ownership, inclusion, “older than”, “larger than”, “more expensive than”, “father of”, “sister of”, “admirer of”, “more massive than”, “more complicated than”, “more popular than”, “higher resolution than”, etc. The orientation of an edge indicates the sense of the relationship. For example, an edge having the meaning “newer model of given device” is directed to indicate which node is older and which node is newer. Thus, when the user views the attention map or the filtered attention map, the user may very easily perceive the relationships between nodes (i.e., between discovered database items).

As noted above, the search is based on a search string including one or more n-grams. Each n-gram is associated with one or more attention contexts. An attention context associated with a given n-gram represents a meaning that has been assigned to the n-gram. An attention context is a prescription (i.e., specification) for the evaluation of the database. For example, the attention context may be a procedure, in which case the semantic search engine computes the attention map by executing the procedure on the database. As another example, an attention context may be an SQL query. An SQL query that selects all items belonging to the category named “cell-phone” would naturally correspond to the meaning “cell phone”.

One n-gram can be related to more than one attention context (homonymy). Also, one attention context can be related to more than one n-gram (synonymy).

When the user enters a sequence of n-grams, the semantic search engine identifies an attention context for each of the n-grams, and generates a partial attention map for each of the identified attention contexts. The partial attention map for each identified attention context is generated by evaluating the database based on that attention context. The partial attention maps are combined together to obtain a resultant attention map. If a given node (e.g., a particular database item) occurs in more than one partial attention map, the attention value for that node in the resultant attention map may be the sum of the node's attention values in the respective partial attention maps. In an alternative embodiment, the attention value for a node in the resultant attention map may be the maximum (or the minimum) of the node's attention values in the respective partial attention maps.

In one embodiment, the user's account stores information specifying a list of n-grams. The user's account may also store information specifying the one or more attention contexts that are associated with each n-gram. If there is more than one attention context associated with a given n-gram, then a preferred or default attention context of the user is selected. The user interface allows the user to force the search engine to use another attention context if the first-suggested attention context (or the presently-suggested attention context) for a given n-gram is not in accord with the user's desire or intent.

In some embodiments, there are two types of attention contexts: basic attention contexts and composed attention contexts.

A basic attention context includes an associated query statement (e.g., an SQL query statement) or a stored procedure. A stored procedure may be used for more complicated queries. For example, a recursive query may be performed using a stored procedure.

In some embodiments, as part of the query for a basic attention context, nodes and edges may be assigned respective attention values and ranked based on attention value. Attention value may be correlated with fact confidence. For example, in some embodiments, the database may include fuzzy facts, where each fuzzy fact (I,C,c) represents the statement that information item I belongs to category C with confidence c. The semantic search engine may query the database using the basic attention context to determine a subset of the fuzzy facts, and then assign attention values to the fuzzy facts of the subset based on their respective fact confidence values c.

A composed attention context is an attention context having the structure of an AND/OR tree, where the leaf elements of the tree are basic attention contexts, and non-leaf elements of the tree are composed attention contexts. In one embodiment, the child elements immediately underneath a given non-leaf element of the AND/OR tree are joined either by the logical OR connection or by the logical AND connection. (According to graph theory, it is traditional to speak of a tree as being composed of “nodes”. However, to avoid confusion with the “nodes” of the attention maps described herein, the AND/OR tree will be described herein as being composed of “elements”. The semantic search engine generates a partial attention map corresponding to the composed attention context by evaluating the database using the AND/OR tree.

FIG. 1B shows one example of an AND/OR tree. Leaf elements C, E, F, G and H are basic attention contexts. Each non-leaf element is a composed attention context which correspond to a logical combination of its child elements. Element A is the composed attention context given by the logical construct “(B AND C) OR D”. Element B is the composed attention context given by the logical construct “E OR F”. Element D is the composed attention context given by the logical construct “G AND H”.

For a composed attention context, a composite attention value for a given node may be computed as a combination (e.g., the sum) of the attention values determined for the given node in the respective attention contexts of the tree.

In some embodiments, each attention context in an AND/OR tree has a defined measure of activation. This measure of activation may serve to emphasize the influence of some attention contexts and diminish the influence of other attention contexts. A measure of activation can also be negative to allow the user to express what he/she doesn't want to see in the search result—for example he doesn't like phones manufactured by company X.

In one embodiment, the composite attention value for each node may be computed as a weighted sum of the attention values of that node relative to the respective attention contexts in the AND/OR tree. The attention values may be weighted using the corresponding activation measures.

The semantic search engine provides the user with access to a dictionary of predefined basic attention contexts. Thus, the user doesn't have to know anything about database queries or procedures. The dictionary is sufficiently rich to cover a range of meanings that are of interest to users of the semantic search engine. For example, a dictionary for an eShop application would be populated with basic attention contexts covering a range of meanings relevant to the types of goods and/or services offered by the eShop. For example, a dictionary of basic attention contexts for a camera shop might include basic attention contexts such as: “SLR cameras”, “cameras under $200”, “high speed cameras”, “cameras by manufacturer X”, “more than 8 megapixels”, “on sale”.

Users can define new n-grams and new meanings for n-grams. The meaning of a new n-gram may be defined by creating a new composed attention context. The user may create a new composed attention context by combining existing attention contexts to form an AND/OR tree or an expression that is equivalent to an AND/OR tree. For example, a new composed attention context for the n-gram “books for John” may be composed using an expression such as “books AND (math OR science)”, where “books”, “math” and “science” are existing attention contexts.

A user of the semantic search engine can associate an alternative meaning to an existing n-gram. This is similar to the situation of defining a new attention context, but in this case the new attention context is assigned to an existing n-gram.

In some embodiments, a client may be associated with the semantic search engine. The client is configured for execution on a client computer, i.e., a computer that is controlled by the user. The client may operate as follows.

The user may enter a word sequence into a search input field (e.g., box or panel) provided on a display screen of the client computer. (In one alternative embodiment, the user may enter the word sequence by speaking it into a microphone of the client computer, the client computer being equipped with speech recognition software to recognize the words spoken by the user.) The client may assist the user in the word-entry process by offering the user a list/set of words that are known to the client and allowing the user to select any of the words. The client may receive the list/set of words from the server over the computer network.

The user can select (e.g., click on) any word and ask the client to explain the word. The word may have one or more meanings. The meaning preferred by the user may be selected first. (The client may store information regarding the user's meaning-preferences.) The user is given the opportunity to request another meaning, e.g., by clicking on a “show me another meaning” button. The client may receive the meanings from the server over the computer network.

The meaning is in general an AND/OR tree. (A basic attention context may be interpreted as a trivial tree with only a root element.) The elements of the tree are attention contexts which have respective words associated with them. When the user asks the client to explain a given word, the client describes the given word in terms of the words associated with the first level down from given word in the corresponding AND/OR tree. This is a recursive process—the user can choose any of these words from the first level down and ask the client to explain the chosen word in terms of words from the first level underneath the chosen word. Thus, for example, when the user asks the client to explain word A of FIG. 1B, the client may return the expression “(B AND C) OR D”.

The user may be given the opportunity to change the explanation (e.g., add new words to or delete some words from the AND/OR tree). This change can be saved for future use, or, used only for the current evaluation, as the user so desires. If the user chooses to save the change, the user is asked to assign a name to the updated AND/OR tree. The user can enter a new word (n-gram), or, choose an existing word (n-gram) to define an alternative meaning for the existing word.

In some embodiments, the user does not necessarily have to enter AND or OR operators, because the server uses heuristic rules to guess relevant operators itself.

In some embodiments, a software system may include a semantic search engine, a visualization engine and an analytical engine. These engines may be configured to execute on the server.

The semantic search engine is able to search for goods and/or services in a manner that is individually customized for each user, according to his/her interests and/or the interests of the people who are important to him.
Example Search: “nice phones (Ted) for my daughter”

The search engine may use the meaning that has been assigned to the term “nice phones” by your friend Ted. Ted is keen on cell-phone design and you trust him in this aspect. The term “for my daughter” was defined by you or your daughter, and contains the information that your daughter likes multimedia phones from Nokia and shoes from Nike with design recommended by her friend Sandra.

In one embodiment, data regarding the user's network of social interconnections is loaded from one or more existing social networks (e.g. Facebook).

In some embodiments, a user may be given the option to find other users based on the similarity of the n-grams and/or meanings they use when performing searches, or, the similarity of the searches they perform through the semantic search engine. People who perceive the world similarly are likely to use similar n-grams and/or meanings, and to ask similar sorts of questions. The semantic search engine may be configured to find other users who are similar to a given user, and, to offer the given user an opportunity to establish social links with the other users. Even if the given user is not interested in establishing a social link with another user, the given user may be presented with an option to view the n-grams and meanings used by the other user (or, at least a subset of the n-grams and meanings that have been designated by the other user for public view).

The visualization engine is configured to facilitate the visualization of search results using attention maps, e.g., 2D attention maps. In one embodiment, each item in an attention map has an attention value that indicates how well the item satisfies the posed question or fits within the range of the posed query.

Attention maps can be manipulated using techniques similar to those used with geographical maps (zooming, panning, signposts). The user can define how he/she wants related search results to be grouped into clusters.

Search Example: nice phones (Ted) for my daughter by producers by price”

This search example specifies clustering on two levels. On the first level, goods are to be clustered according to producer—e.g. Nokia, Siemens, Sony, etc. On the second level, goods are to be clustered according to price. Thus, the attention map may include clusters corresponding to distinct producers. However, each cluster may include one or more subclusters corresponding to distinct price ranges (e.g., low, middle and high price subclusters).

The visualization engine may be configured to adapt to whatever is important for the individual user/customer and present search results in a multidimensional and interactive way. In general, each user has a different view of how things are related and that view is reflected in the semantic constructs (the meanings) and the associated words and word sequences constructed/used by the user.

The analytical engine allows a shopkeeper to gain insight into the customer community by analyzing the usage of various attention maps by customer segments, by analyzing the profitability associated with attention maps, and by identifying opinion makers in the customer community. (In the context of an electronic business/shop, the attention maps may be referred to as “shopping maps”.) Thus, the shopkeeper can better understand customer interests and find inspiration for improvement of the online business/shop. For example, the shopkeeper may define new words, word sequences and word meanings that he/she believes are likely to be useful and/or attractive to customers.

The analytical engine may perform an analysis of each customer's usage of attention maps, and determine a pattern of usage or pattern of interests characteristic of the customer, and determine how the customer's interests are evolving over time. This information may be used to more effectively target newsletters to respective customers.

The semantic search engine and/or visualization engine may store (and maintain) information regarding a user's interaction with the semantic search engine and/or the visualization engine. For example, the stored information may include: information regarding the frequency of use of words, word sequences and meanings; the words, word sequences and meanings that the user has shared with other users; and the identity of those other users (i.e., what is shared with whom); the user's preferred way of visualizing search results, i.e., of visualizing the attention maps (e.g., user X may consider price a more important criteria than brand, while user Y may consider brand more important than price); the ways of focusing attention that are preferred by the user (e.g., brands, categories, etc.); information regarding whether the user's walk through a given attention map was finished by a decision to buy.

The analytical engine may operate on the stored information to determine: which shopping maps are used with the highest frequency; the kinds of customers who use the high-frequency shopping maps; the profitability of various shopping maps (e.g, the ratio of looking-concluded-with-buy to looking-with-or-without-buy for each shopping map); and the identity of the opinion makers in a given segment of the customer community. A user may be identified as an opinion maker if a large number of other users decide to use the words, word sequences or meanings created by that user.

In some embodiments, the analytical engine may include a view selector and a view browser. The view selector allows a shopkeeper to select a view that contains the information that he/she desires. The view browser allows the shopkeeper to visualize the desired information.

In some embodiments, a portion of the database may be organized in terms of “T-structures”. That portion may be referred to herein as “T-space”. A T-structure may be interpreted as a vector (I, C, c, K, a), where: I is an item; C is a category; c is a value indicating the degree of confidence that I belongs to category C; K is a context; and a is an attention value that represents how valid, appropriate or worthy of attention the fuzzy fact (I, C, c) is relative to context K. The fuzzy fact (I,C,c) is the statement that I belongs to C with confidence c.

T-structures may be used in a process of preparing an index for a given database. They may be used to represent collected data about products (e.g., properties of products, categorization of products, and relationships between products). T-structures may be transformed into indexes which can be used by the search engine. These indexes may have a more compact form than the database itself, and thus, may be more suitable for quick searching.

As described above, confidence is modeled as part of a T-structure (e.g., the confidence that a given cell phone is suitable for children). Confidence can be derived from external data sources or it can be deduced from other properties during the process of index preparation. (For example, a given cell phone may be highly suitable for children if it has a large display, is durable, and is simple to use.)

During the search process, the semantic search engine may rank items based on attention value. In many situations, the attention value may be correlated with confidence value. For example, attention value may be proportional to (or a monotonically increasing function of) confidence value. However, more general relationships are contemplated between attention and confidence.

In some embodiments, edges (or relations) may be modeled using T-structures. A binary relation for example may be represented as a T-structure that relates two T-structures T1 and T2 relative to the context K. For example, as shown in FIG. 1C, the father-son relationship between Matt (represented by structure T1) and his father John (represented by structure T2) can be modeled as follows:

T1=Matt is a son in context K. (Matt plays the role of son in context K).

T2=John is a father in context K. (John plays the role of father in context K).

A query of T-space might be expressed as:

Does John play the role of father (in any context)?

That query may be implemented in terms of a database query that looks like:

Does John belong to the category “fathers” (in any context)?

Because each T-structure has a unique identifier, it can be interpreted as an item, and thus, incorporated as a part of other T-structures. This incorporation ability may be used to model relationships between T-structures.

T-structures can be connected in various ways. For example, a category in one T-structure can be an item in another T-structure. (The category “father” might be interpreted as an item belonging to the category “categories that model social roles”.) Furthermore, a context in one T-structure can be an item in another T-structure. (The context “facts about the President's brother” may be interpreted as an item relative to the context “contexts of the President's life”.)

Attention contexts used by the semantic search engine are not necessarily in a one-to-one relation with contexts from T-space. An attention context is a prescription (or procedure) that generates nodes and edges. A context in T-space is used to organize facts into T-structures.

In some embodiments, an attention context evaluates the content of some category, and attention is derived from confidence. For example, an attention context that selects cell-phones on the basis of suitability for children may be implemented by evaluating the category “suitable for children”. The resulting nodes may have attention value proportional to (or a monotonic function of) confidence value.

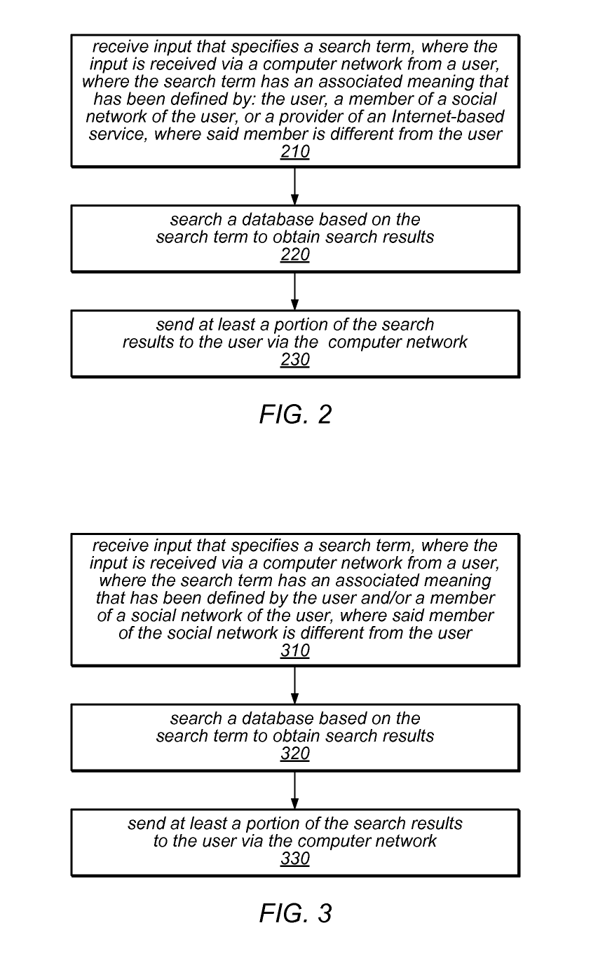

In one set of embodiments, a computer-implemented method 200 for searching a database may include the following operations, as shown in FIG. 2.

At 210, a computer system such as computer system 100 may receive input that specifies a search term. The input may be received via a computer network (e.g., the Internet) from a user, i.e., from a client computer that is controlled by a user. The search term has an associated meaning that has been defined by: the user, a member of a social network of the user, or a provider of an Internet-based service. The social network member is different from the user.

The “meaning” of the search term may be a prescription (or specification) for evaluating (i.e., searching) a database. The “meaning” of the search term may be an attention context as variously discussed above. The database may be database that includes T-structures, as discussed above.

At 220, the computer system may search the database based on the search term to obtain search results. In some embodiments, the search results take the form a graph that includes nodes and edges. The nodes may represent items of information. The edges may represent relationships between the nodes.

At 230, the computer system may send at least a portion of the search results to the user, i.e., the client computer, via the computer network. The client computer may display the search results using a display device such as a monitor, a projector, a head mounted display, etc.

In one embodiment, the Internet-based service provider is an Internet-based business, where the database stores information regarding items offered for sale by the Internet-based business.

In another embodiment, the Internet-based service is a job search service, where the database stores information regarding offers for employment.

In yet another embodiment, the Internet-based service is a service for searching real estate properties, where the database stores information regarding real estate properties.

In yet another embodiment, the Internet-based service is a service for searching events generated by one or more monitoring systems, where the database stores information regarding the events generated by the one or more monitoring systems. For example, a monitoring system may be configured to monitor a computer network, i.e., to capture events regarding use of the computer network. The method 200 may be useful in isolating and/or discovering events that are worthy of the network administrator's attention, e.g., events that indicate security offenses. As another example, a monitoring system may be configured to monitor intelligent buildings. The monitoring system may capture measurements from devices distributed throughout the building. The method 200 may be useful in discovering events are that worthy of the building administrator's attention, e.g., maintenance problems such as device failures, suspicious values of measured characteristics, leaking valves, etc. As yet another example, a monitoring system may be configured to monitor transactions in distribution networks (e.g., networks of gas stations). The method 200 may be used to detect suspicious transactions that indicate the possibility of fraud or theft.

In one set of embodiments, a computer-implemented method for searching a database may include the following operations, as shown in FIG. 3.

At 310, a computer system such as computer system 100 receives input that specifies a search term, where the input is received via a computer network from a user, i.e., from a client computer controlled by the user. The search term has an associated meaning that has been defined by the user and/or a member of a social network of the user, where the member of the social network is different from the user.

At 320, the computer system searches a database based on the search term to obtain search results, e.g., as variously described above. The database may be a database including T-structures as described above.

At 330, the computer system sends at least a portion of the search results to the user (i.e., to the client computer) via the computer network.

In one embodiment, the search term is a word sequence, where the meaning of the search term is represented by an AND/OR tree. Each leaf element of the AND/OR tree specifies a corresponding prescription for the evaluation (search) of the database. The process 320 of searching the database includes searching the database based on the AND/OR tree. For example, searching the database based on the construct “phones-under-$200” AND phones-by-Nokia” would discover phones that satisfy both conditions.

In some embodiments, the action of searching the database based on the AND/OR tree produces a graph including nodes and edges, e.g., as variously described above.

In some embodiments, the search term is a word, and the meaning of the search term is represented by an SQL query. Thus, the process 320 of searching the database may include searching the database using the SQL query.

In some embodiments, the search term is a word, and the meaning of the search term is represented by a procedure. Thus, the process 320 of searching the database may include searching the database using the procedure.

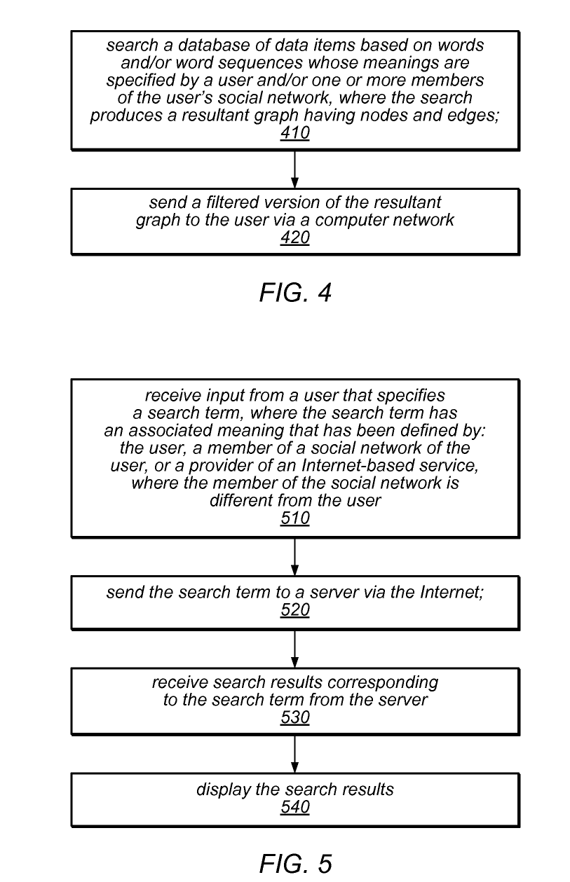

In one set of embodiments, a computer-implemented method 400 for searching a database may include the following operations, as shown in FIG. 4.

At 410, a computer system such as computer system 100 searches a database of data items based on words and/or word sequences whose meanings are specified by a user and/or one or more members of the user's social network. The search produces a resultant graph having nodes and edges. The data items may include T-structures as described above.

At 420, the computer system sends a filtered version of the resultant graph to the user (i.e., a client computer that is controlled by the user) via a computer network.

In some embodiments, the method 400 may also include receiving input from the user (i.e., from the client computer) defining the meaning of one of the words or word sequences prior to said search, e.g., by specifying an AND/OR tree in terms of previously-existing meanings, as described above.

The method 400 may also involve receiving input indicating the user's election to share the meaning with another user.

In one embodiment, the database is a database of job offers. In another embodiment, the database is a database of offers for service by businesses. In yet another embodiment, the database is a database of information regarding real estate properties. In yet another embodiment, the database is a database of information regarding events generated by one or more monitoring systems as described above.

In some embodiments, the nodes of the resultant graph represent items from the database that have been identified by said search. The edges of the resultant graph may represent relationships between the items.

In some embodiments, the method 400 also includes: assigning an attention value to each node in the resultant graph; and ranking the nodes in the resultant graph according to the assigned attention values. The attention value may represent the extent to which the node satisfies the query defined by the given attention context. For example, the attention value for the attention context X=“inexpensive phones” may be a decreasing function of phone price. As another example, the attention value for the attention context Y=“inexpensive-camera AND high-resolution-camera” may be an increasing function of the ratio R/P, where R is camera resolution and P is camera price. As yet another example, the attention value for the attention context Z=“high-starting-salary OR high-days-vacation” may be an increasing function of max {starting salary, days of vacation}.

In some embodiments, the method 400 also includes: assigning an attention value to each edge in the resultant graph, e.g., as variously described above; and ranking the edges in the resultant graph according to the assigned attention values.

In some embodiments, the method 400 also involves filtering the resultant graph according to one or more filtering rules to obtain the filtered version of the resultant graph. The filtering operation may involve eliminating nodes from the resultant graph that have an attention value less than a threshold value specified by the user. (Each of the nodes of the resultant graph has a corresponding attention value.)

In some embodiments, the meaning of each word or word sequence is defined by an associated attention context that specifies a prescription for evaluation of the database.

In one embodiment, the words and/or word sequences used to perform the search include a word whose associated attention context specifies an SQL query.

In one embodiment, the words and/or word sequences used to perform the search include a word whose associated attention context specifies a stored procedure.

In some embodiments, the words and/or word sequences used to perform the search include a first word sequence, where the attention context associated with the first word sequence specifies an AND/OR tree. The leaf elements of the AND/OR tree are attention contexts, each of which specifies a corresponding prescription for evaluation of the database. In one embodiment, the attention content associated with the first word sequence includes a measure of activation as discussed above.

In some embodiments, the AND/OR tree is evaluated by an algorithm or defined procedure that computes a corresponding graph.

As described above, the database is searched based on a number of words and/or word sequences. The meaning of each word or word sequence is defined by an associated attention context that specifies a prescription for evaluation of the database. In some embodiments, the process of searching the database includes performing a number of searches of the database based respectively on the associated attention contexts to obtain respective partial graphs. The partial graphs may be combined to form the resultant graph.

In some embodiments, the computer system may receive input from the user defining a new attention context based on two or more previously-existing attention contexts. Each of the previously-existing attention contexts specifies a corresponding prescription for evaluating the database. The input from the user specifies an AND/OR tree structure for the two or more previously-existing attention contexts. The new attention context may be stored in a memory for use in future searches. Furthermore, a new word or word sequence may be assigned to the new attention context in response to additional input from the user.

In some embodiments, the computer system may also receive input from the user associating a different attention context to an existing word or word sequence in order to change the meaning of the word or word sequence.

In one set of embodiments, a computer-implemented method for invoking a database search may involve the following operations, as illustrated in FIG. 5.

At 510, a computer system such as computer system 100 may receive input from a user that specifies a search term. The search term has an associated meaning that has been defined by: the user, a member of a social network of the user, or a provider of an Internet-based service. (The member of the social network is different from the user.)

At 520, the computer system may send the search term to a server via the Internet.

At 530, the computer system may receive search results corresponding to the search term from the server. The server may be owned and/or operated by the Internet-based service.

At 540, the computer system may display the search results, or, at least a portion of the search results using a display device such as a monitor, a projector, a display screen, etc.

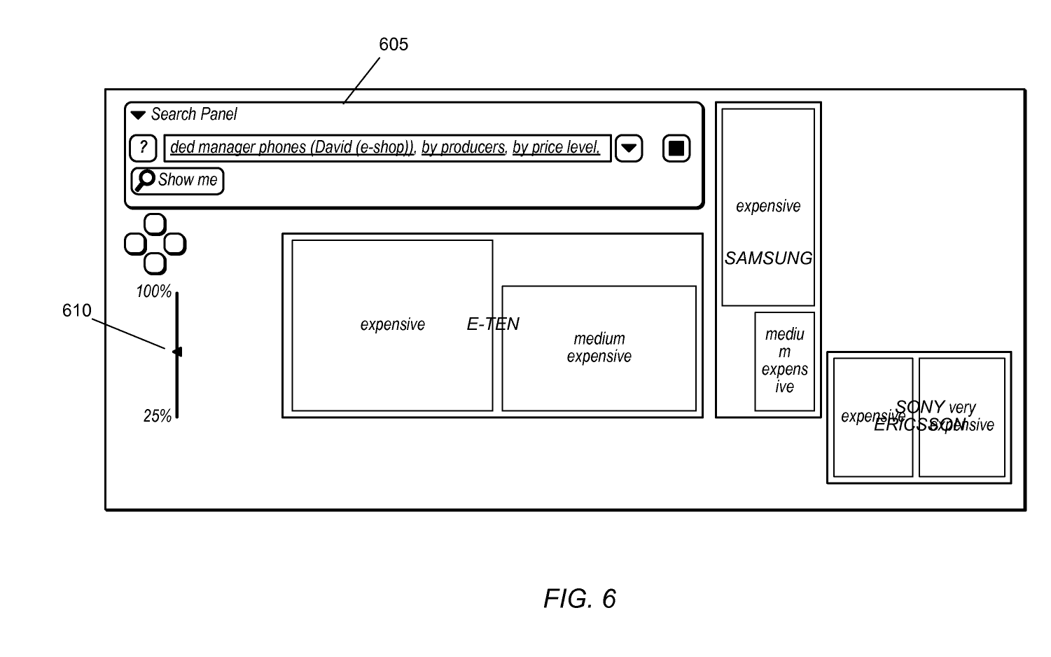

FIG. 6 illustrates an example of a shopping map generated in response to the search term “ded manager phone (David (e-shop)), by producers, by price level”, which is entered by the user in an input field of search panel 605. The word “ded manager phone” has been defined by David of the e-shop. The slider control 610 at the left determines a level of zoom; the zoom is both visual and semantic at the same time. The position of the slider controls an attention value threshold, and the attention value threshold determines which nodes and edges will be made visible. Zooming-in causes more nodes and edges to be visualised. The shopping map organizes the presentation of cell phone information based first on producer and then on price. Thus, information regarding producers (such as E-TEN, Samsung, Sony Ericsson) is grouped together. Then, within each group, information is organized into subgroups corresponding to distinct price ranges (such as cheap, medium expensive, expensive, very expensive).

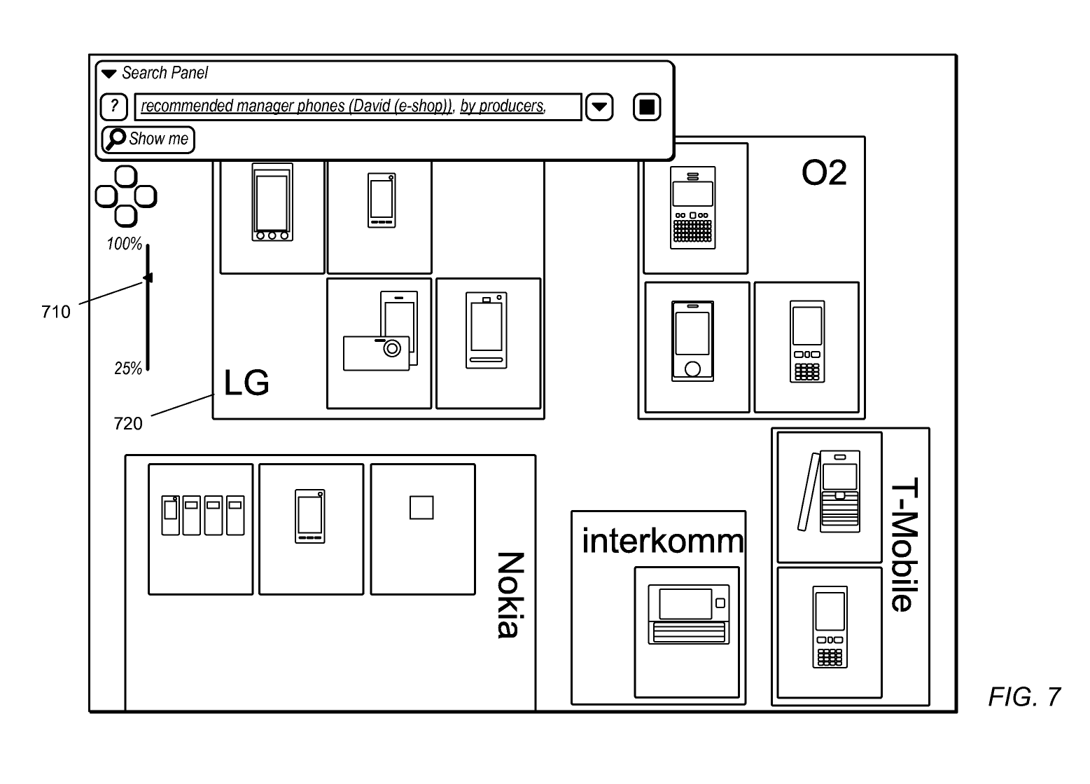

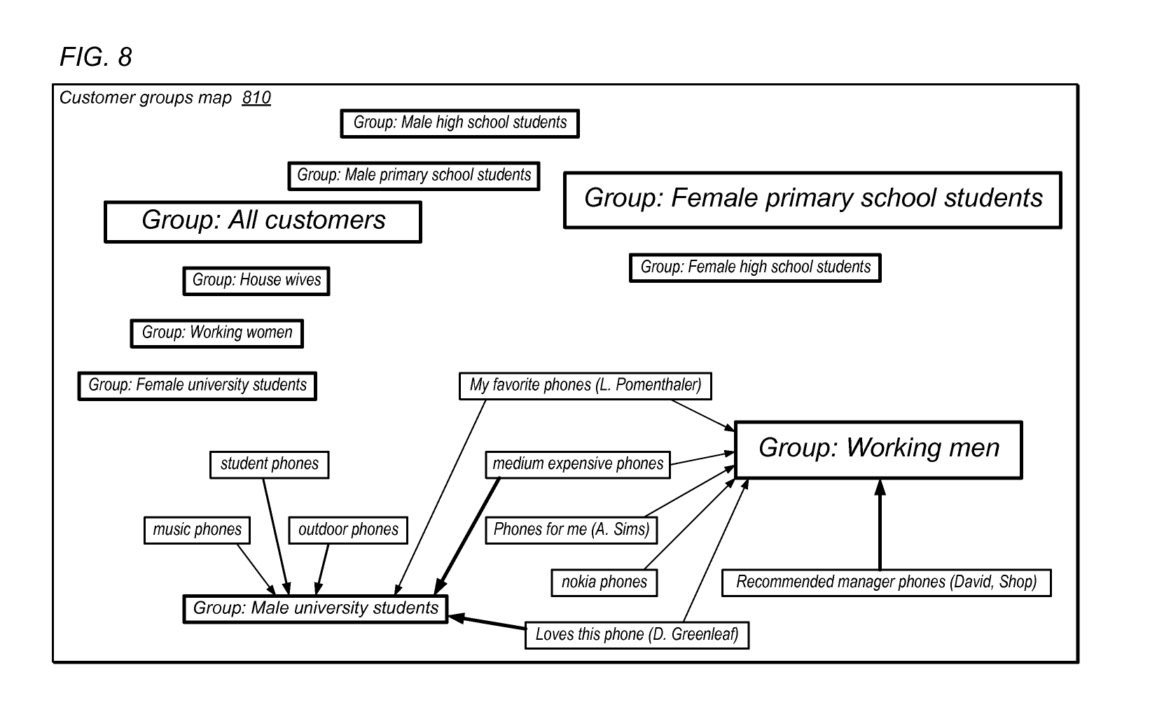

FIG. 7 illustrates an example of a shopping map generated in response to the search term “recommended manager phones (David (e-shop)), by producers”. Information on cells phones is grouped based on producer. In the illustrated example, the producers include LG, O2, Nokia, T-Mobile, interkomm. Thus, e.g., information regarding LG phones is displayed together in a group 720.

FIG. 8 illustrates an example of a customer groups map 810 generated by the analytical engine. The map shows various customers groups and various words/terms/n-grams, and indicates the frequency with which given words/terms/n-grams are used by given groups. The frequency of use may be indicated by the density of the arrow connecting a word/term/n-gram to a group. Thus, the group “working men” use the term “recommended manager phones (David, Shop)” with higher frequency than the term “My favorite phones (L. Pomenthaler)”. Furthermore, the size of a group may be indicated by the font size of the group name. A wide variety of other graphical means are contemplated for indicating usage frequency and/or group size.

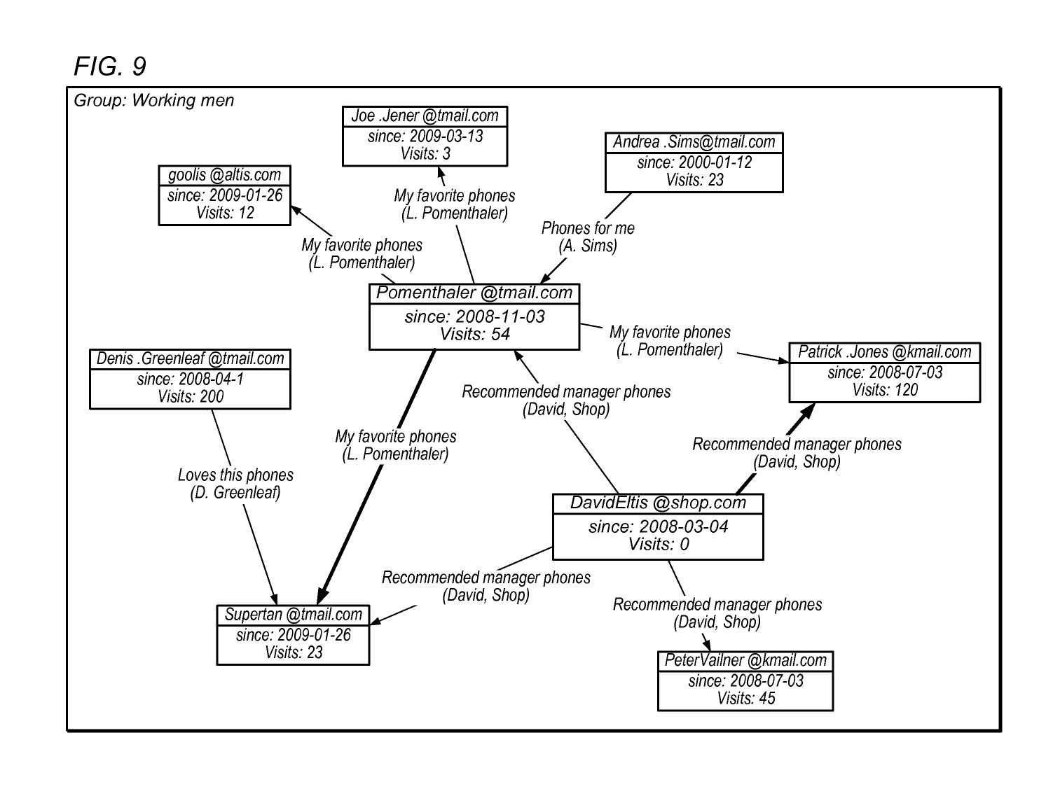

FIG. 9 illustrates an example of a view that shows relationships within a given group, i.e., within the group “working men”. The group includes nine users. The group is illustrated as a graph, where nodes are the users, and edges indicate that where a word/word sequence/n-gram created by one user has been used by another user. For example, pomenthal@tmail.com has used the n-gram “recommended manager phones” that was created by DavidEltis®shop.com. The line density (or thickness) of an edge connecting X to Y may indicate the frequency with which Y has used the n-gram created by X. Thus, Supertan has used “my favorite phones” created by Pomenthaler more frequently than “Loves this phone” created by Denis.Greenleaf. The number of visits associated with a user indicates how many times the user entered the e-shop.

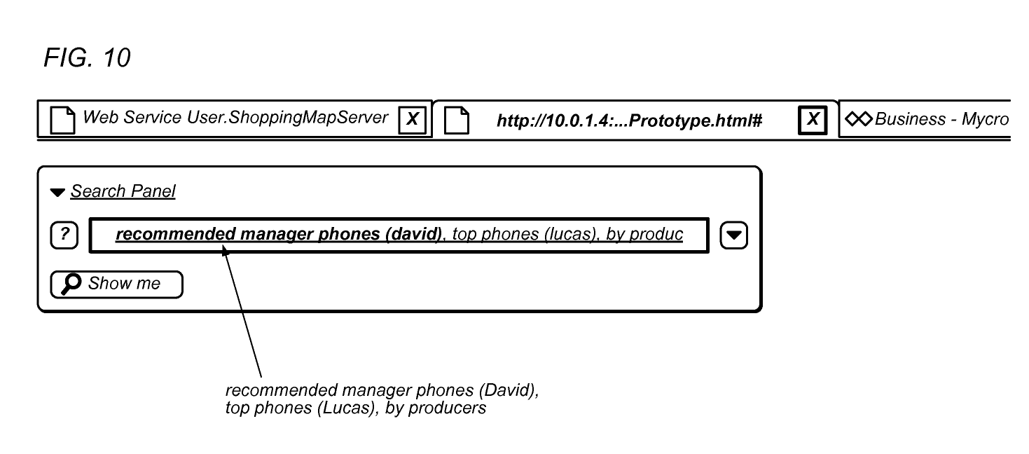

FIG. 10 illustrates an example of a search being performed based on the search term “recommended manager phones (David), top phones (Lucas), by producers”. Thus, the user who is performing the search has constructed a search term that is a combination of terms defined by two other persons, i.e., David and Lucas.

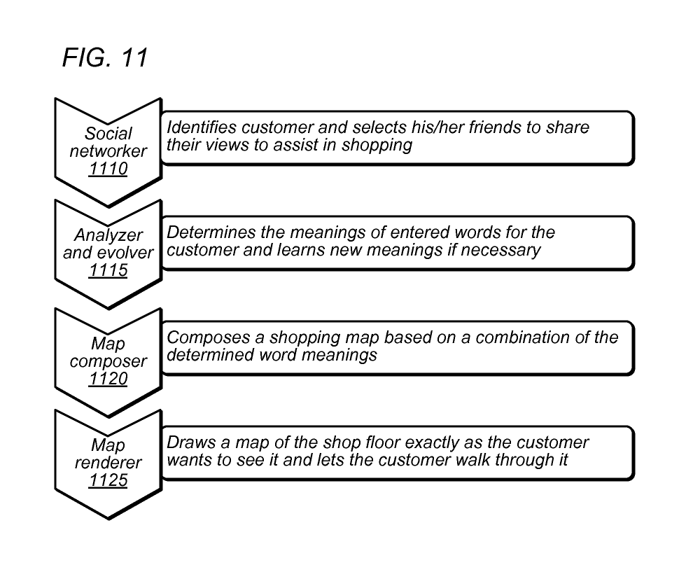

FIG. 11 illustrates one embodiment for a software system includes a social networker 1110, an analyzer-and-evolver 1115, a map composer 1120, and a map renderer 1125. The social networker may identify the customer and select (or identify) his/her friends in order to share their views with the customer, and thus, to assist the customer in shopping. The analyzer and evolver may determine the meaning of entered words for the customer and learn new meanings if necessary. The map composer may compose a shopping map based on a combination of the determined word meanings. The map renderer may draw a map of the shop floor exactly as the customer wants to see it and lets the customer walk through the map.

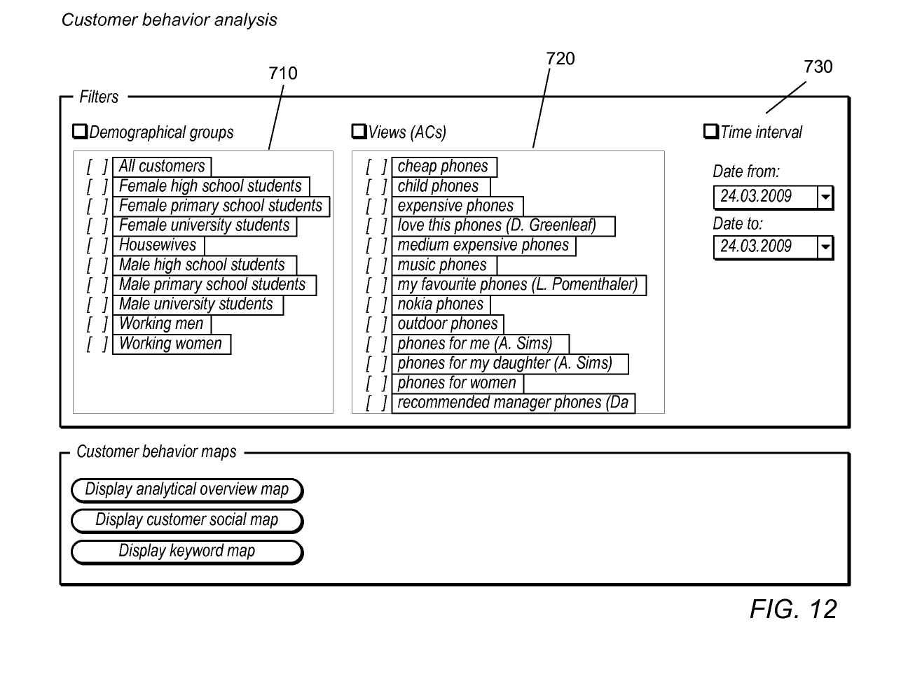

FIG. 12 illustrates one embodiment of a “customer behavior analysis” view that lists demographical groups 710, views (attention contexts) 720 and a time interval interface 730. This view may be used to select a demographical group and/or to select an attention context and/or to select a time interval. Clicking one of the three buttons, ‘Display analytical overview map’ or ‘Display customer social map’ or ‘Display keyword map’, a requested map view is generated.

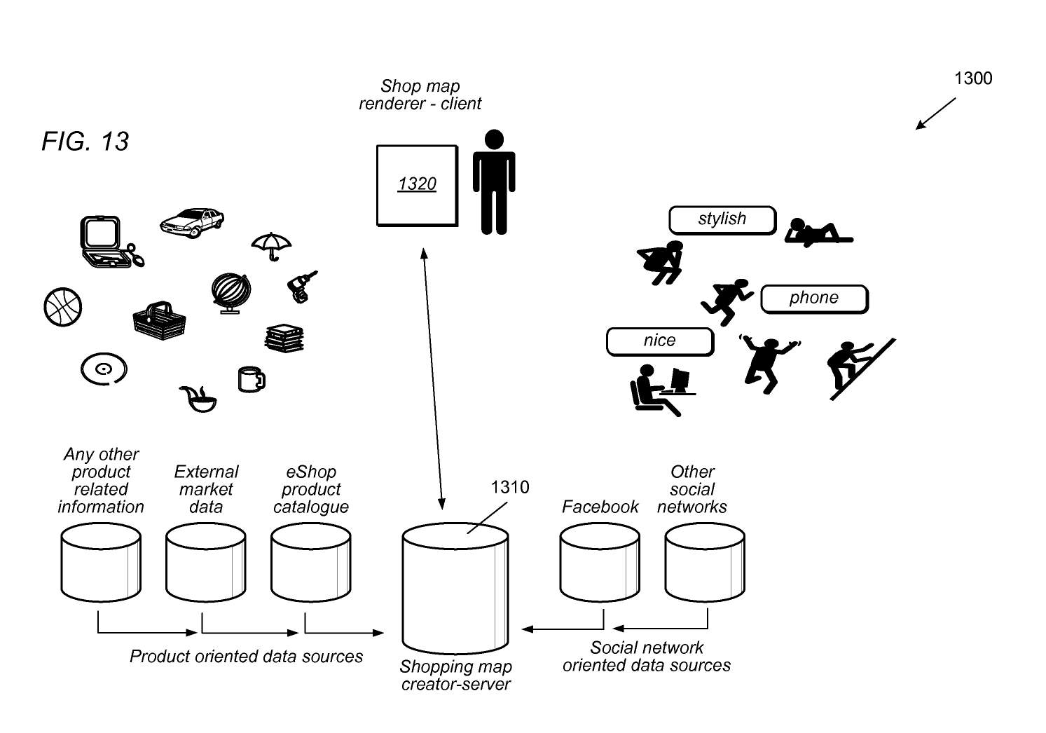

FIG. 13 illustrates one embodiment of a system 1300 for performing socially informed searching of a database. The shopping map creator-server 1310 interacts with a shopping map renderer-client 1320 through a computer network such as the Internet. The creator-server receives product-oriented data from various sources including sources of external market data and eShop product catalogs. The creator-server receives social network data from any of various sources such as Facebook, Linked-In, MySpace, etc.

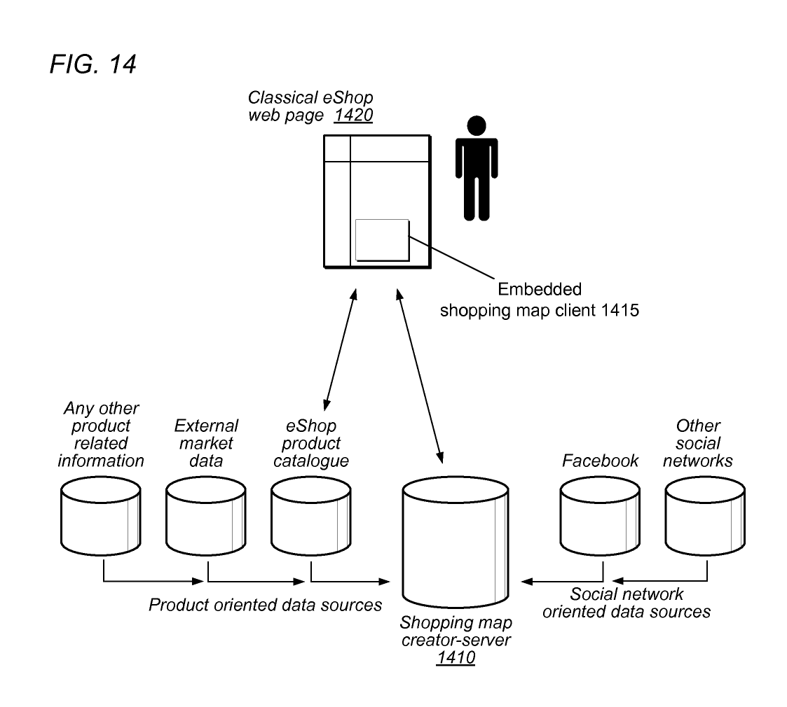

FIG. 14 illustrates another embodiment of the system for performing socially informed searching of a database. In this embodiment, the shopping map renderer-client 1415 may be embedded within a classical eShop web page 1420. For example, an online merchant may elect to incorporate the shopping map renderer-client within one or more of his/her web pages. The shopping map creator-server 1410 may be controlled by the online merchant or by a third party that has established a relationship with the online merchant.

The shopping map client and the shopping map creator-server may be configured to provide customers of the web site with access to product data.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computer-accessible memory medium storing program instructions, wherein the program instructions are executable by a computer system, wherein the program instructions, if executed by the computer system, cause the computer system to:
receive input that specifies a search term, wherein the input is received via a computer network from a first user, wherein the search term has an associated meaning that has been defined by: the first user, a member of a social network of the first user, or a provider of an Internet-based service, wherein said member is different from the first user;
search a database based on the search term to obtain search results; and
send at least a portion of the search results to the first user via the computer network.

2. The memory medium of claim 1, wherein the Internet-based service provider is an Internet-based business, wherein the database stores information regarding items offered for sale by the Internet-based business.

3. The memory medium of claim 1, wherein the Internet-based service is a job search service, wherein the database stores information regarding offers for employment.

4. The memory medium of claim 1, wherein the Internet-based service is a service for searching real estate properties, wherein the database stores information regarding real estate properties.

5. The memory medium of claim 1, wherein the Internet-based service is a service for searching events generated by a monitoring systems, wherein the database stores information regarding the events generated by the monitoring systems.

6. A computer-accessible memory medium storing program instructions, wherein the program instructions are executable by a computer system, wherein the program instructions, if executed by the computer system, cause the computer system to:
receive input that specifies a search term, wherein the input is received via a computer network from a first user, wherein the search term has an associated meaning that has been defined by the first user and/or a member of a social network of the first user, wherein said member of the social network is different from the first user;
search a database based on the search term to obtain search results; and
send at least a portion of the search results to the first user via the computer network.

7. The memory medium of claim 6, wherein the search term is a word sequence, wherein the meaning of the search term is represented by an AND/OR tree, wherein each element of the AND/OR tree specifies a corresponding prescription for evaluation of the database, wherein said searching includes searching the database based on the AND/OR tree.

8. The memory medium of claim 7, wherein said searching the database based on the AND/OR tree produces a graph including nodes and edges.

9. A computer-accessible memory medium storing program instructions, wherein the program instructions are executable by a computer system, wherein the program instructions, if executed by the computer system, cause the computer system to:
search a database of data items based on words and/or word sequences whose meanings are specified by a user and/or one or more members of the user's social network, wherein said search produces a resultant graph having nodes and edges; and
send a filtered version of the resultant graph to the user via a computer network.

10. The memory medium of claim 9, wherein the program instructions, if executed by the computer system, further cause the computer system to:
receive input from the user defining the meaning of one of the words or word sequences prior to said search.

11. The memory medium of claim 10, wherein the program instructions, if executed by the computer system, further cause the computer system to:
receive input indicating the user's election to share the meaning with another user.

12. The memory medium of claim 9, wherein the database is a database of offers for service by businesses or a database of information regarding real estate properties or a database of job offers.

13. The memory medium of claim 9, wherein the database is a database of information regarding events generated by a monitoring system.

14. The memory medium of claim 9, wherein the nodes of the resultant graph represent items from the database that have been identified by said search, wherein edges of the resultant graph represent relationships between said items.

15. The memory medium of claim 9, wherein the program instructions, if executed by the computer system, further cause the computer system to:
assign an attention value to each node in the resultant graph; and
rank the nodes in the resultant graph according to the assigned attention values.

16. The memory medium of claim 9, wherein the program instructions, if executed by the computer system, further cause the computer system to:
assign an attention value to each edge in the resultant graph; and
rank the edges in the resultant graph according to the assigned attention values.

17. The memory medium of claim 9, wherein the program instructions, if executed by the computer system, further cause the computer system to:
filter the resultant graph according to one or more filtering rules to obtain the filtered version of the resultant graph.

18. The memory medium of claim 17, wherein each of the nodes of the resultant graph has been assigned a corresponding attention value, wherein said filtering eliminates nodes from the resultant graph that have corresponding attention value less than a threshold value specified by the user.

19. The memory medium of claim 9, wherein the meaning of each word or word sequence is defined by an associated attention context that specifies a prescription for evaluation of the database.

20. The memory medium of claim 19, wherein said words and/or word sequences include a first word, wherein the attention context associated with the first word specifies an SQL query or a stored procedure.

21. The memory medium of claim 19, wherein said words and/or word sequences include a first word sequence, wherein the attention context associated with the first word sequence specifies an AND/OR tree whose elements are attention contexts, each of which specifies a corresponding prescription for evaluation of the database.

22. The memory medium of claim 19, wherein said searching includes:
performing a number of searches of the database based respectively on the associated attention contexts to obtain respective partial graphs; and
combining the partial graphs to form said resultant graph.

23. The memory medium of claim 19, wherein the program instructions, if executed by the computer system, further cause the computer system to:
receive input from the user, said input defining a new attention context based on two or more previously-existing attention contexts, wherein each of the previously-existing attention contexts specifies a corresponding prescription for evaluating the database, wherein said input specifies an AND/OR tree structure for the two or more previously-existing attention contexts; and
store the new attention context in a memory.

24. A computer-accessible memory medium storing program instructions, wherein the program instructions are executable by a computer system, wherein the program instructions, if executed by the computer system, cause the computer system to:
receive input from a first user that specifies a search term, wherein the search term has an associated meaning that has been defined by: the first user, a member of a social network of the first user, or a provider of an Internet-based service, wherein the member of the social network is different from the first user;
send the search term to a server via the Internet; and
receive search results corresponding to the search term from the server; and
displaying the search results.
